(19) United States
(12) Patent Application Publication
(10) Pub. No.: US 2026/0151772 A1
(43) Pub. Date: Jun. 4, 2026

(54) Adapter and rail for liquid handling applications and method thereof

(71) Applicant: Sartorius Liquid Handling oy, Helsinki (FI)

(72) Inventor: Tuomas Kuitunen, Helsinki (FI)

(21) Appl. No.: 19/403,321

(22) Filed: Nov. 28, 2025

(30) Foreign Application Priority Data
Dec. 4, 2024 (EP) 24217452.2

(51) Int. Cl. B01L 9/00; B01L 3/02

(52) U.S. Cl. CPC B01L 9/54; B01L 3/021; B01L 2200/022; B01L 2200/023

(57) ABSTRACT

According to an example aspect of the present invention, there is provided an adapter for holding a pipette, the adapter comprising a body element, said body element configured to hold a pipette; wherein the adapter is configured to be attached to at least one rail at any point along the rail, said at least one rail comprising at least one electrical conductor, said electrical conductor extending at least partially along the length of the at least one rail.

### FIELD

This disclosure provides a mounting solution for devices, in particular in the field of liquid handling applications such as pipettes. More specifically, the present disclosure provides a mounting system for flexible adjustment of electronic pipettes on and along a rail.

### BACKGROUND

In laboratories or similar scientific or industrial settings, it is beneficial to have easily attainable liquid handling devices for routine or very precise work. Rechargeable batteries of electronic pipettes are typically charged by placing said pipettes on a charging rack. Such charging racks are typically designed for a specific pipette model and shape, or to a narrow selection of pipettes and pipette models. Different pipette geometries and charging contact positions set specific demands and restrictions for applicable and suitable pipette models, as well as the number of pipettes on a charging rack. Laboratory use cases may have needs for pipette racks which provide flexibility and adjustability, for example when using multiple types of pipette.

### SUMMARY OF THE INVENTION

The invention is defined by the features of the independent claims. Some specific embodiments are defined in the dependent claims.

According to a first aspect of the present invention, there is provided an adapter for holding a pipette, the adapter comprising: a body element, said body element configured to hold a pipette; wherein the adapter is configured to be attached to at least one rail at any point along the rail, said at least one rail comprising at least one electrical conductor, said electrical conductor extending at least partially along the length of the at least one rail.

According to a second aspect of the present invention, there is provided a rail for holding at least one pipette, the rail comprising: at least one electrical conductor, said electrical conductor extending at least partially along the length of the rail, wherein the rail is configured to allow at least one adapter may to be attached at any point along the rail, the adapter comprising a body element configured to hold a pipette, wherein the rail is configured to be attached to at least one connector element, said connector element attached to at least one of: a wall mount, a support leg, or a second rail.

According to a third aspect of the present invention, there is provided a system comprising an adapter in accordance with the first aspect and a rail in accordance with the second aspect, wherein the adapter is optionally attached to the rail.

According to a further aspect of the first or third aspects, the adapter comprises a charging element, wherein the adapter is configured to connect the charging element to the at least one electrical conductor of the at least one rail when the adapter is attached to the at least one rail, and wherein the charging element comprises at least one of: an electrical contact, a wire, or a coil configured for wireless charging.

### BRIEF DESCRIPTION OF THE DRAWINGS

FIGS. 1A, 1B and 1C illustrate examples of pipette rack arrangements in accordance with at least some embodiments of the present invention;

FIGS. 2A, 2B and 2C illustrate examples of pipette rack arrangements in accordance with at least some embodiments of the present invention;

FIGS. 3A, 3B, 3C and 3D illustrate exemplary rail profiles in accordance with at least some embodiments of the present invention;

FIGS. 4A, 4B, 4C, 4D, 4E and 4F illustrate exemplary adapters in accordance with at least some embodiments of the present invention;

FIGS. 5A, 5B and 5C illustrate exemplary rails and adapters in accordance with at least some embodiments of the present invention;

FIGS. 6A, 6B and 6C illustrate exemplary rails and adapters in accordance with at least some embodiments of the present invention;

FIGS. 7A, 7B and 7C illustrate exemplary rails and adapters in accordance with at least some embodiments of the present invention;

FIGS. 8A, 8B and 8C illustrate examples of pipette rack arrangements adapters in accordance with at least some embodiments of the present invention; and

FIGS. 9A and 9B illustrate examples of pipette rack arrangements adapters in accordance with at least some embodiments of the present invention.

### EMBODIMENTS

Embodiments of the present disclosure provide at least one of an adapter and a rail, usable for liquid handling applications, as well as methods and uses thereof. More specifically, the present disclosure allows for easy attachment of liquid handling devices such as pipettes, electronic or mechanical, to the rail, as well as a possibility to rapidly attach, adjust the position of, or remove such pipettes. At least some of these goals may be achieved using an adapter. Moreover, at least some embodiments of the present disclosure provide improved placement opportunities for pipettes via adapters attachable to rails. The adapters disclosed herein are suitable for, for example, mounting electronic pipettes on a rail. Said adapters may provide charging and/or data communication capabilities to the mounted pipettes. The rails disclosed herein may be extendable and attachable to connector elements. The rails may be capable of providing charging for the electronic pipette from the rail via an adapter, for example.

The term “pipette”, “pipet”, or “pipettor” as used in the context of the present disclosure is to be understood as a liquid media dispenser and a liquid handling device capable of collecting and transferring a measured volume of liquid. Typically, a pipette comprises a plunger, a body, tip holder, disposable/removable pipette tip and tip ejector button as well as mechanisms for liquid volume displacement and volume adjustment. Such pipettes may be, for example, single channel pipettes or multi-channel pipettes. A pipette may be capable of disposing volumes of approximately less than 1000 μl, microliters, are often termed micropipettes.

The embodiments of this disclosure are suitable for use with single-channel, multichannel, or other types of pipettes. The embodiments are suitable for both mechanical and electronic pipettes, as will be discussed further within the disclosure.

Typically, the body of a pipette comprises a shape such that it may be removably attachable to a holder, such as a rack or a rod, or a bar. Such “attachment part” may be a shaped protrusion or a hook attachment on the plunger-end of the pipette. Using the attachment part, the pipette may be hung, for example, on a pipette rack.

The term “electronic pipette” as used in the context of the present disclosure is to be understood as a pipette, such as a micropipette, comprising at least one electronic component, for example an electric motor, as the primary actuator for liquid volume displacement, collection and/or transfer. An electronic pipette may comprise an electrically actuated pipette device. Thus, an electronic pipette typically needs charging, for example charging of batteries connected to or comprised within the pipette. Such an “electronic pipette” may comprise charging contacts for charging said electronic pipette. In at least some embodiments, the electrical contacts may be used for data transfer. Alternatively charging and/or data transfer may be done via, for example, induction between a coil of an adapter and a coil of electronic pipette. An example of an electronic pipette is a Sartorius Picus 2 Electronic Single Channel Pipette, item number LH-747021.

The term “mechanical pipette” as used in the context of the present disclosure is to be understood as pipettes, such as micropipettes, not having electronics as a primary solution for liquid volume displacement, collection and/or transfer. In general, such pipettes do not need to be electrically charged, or are charged infrequently. An example of a mechanical pipette is a Sartorius Tacta Mechanical Pipette, Single Channel, Item no. LH-729010.

A “rack”, or a “pipette rack” is to be understood as a holder for pipettes, for example electronic pipettes or mechanical pipettes. Pipettes may be removably attachable from said holder, for example while said pipettes are not in use. A “linear pipette rack” typically comprises a bar or a rod on which pipettes such as micropipettes may be placed. Such a bar or rod is typically linear, in other words substantially elongated such that even a plurality of pipettes with suitable substantially complementary profiles may be attached to, or “hang” from, typically via at least in part of the body of the pipette.

In this disclosure, several elements, parts, modules, or assemblies are attached to each other. Such attachment may be facilitated by any of the following solutions singly or jointly: mechanical hinge, mechanical joint, adhesive, hook-or-loop fastener, screws, bolts, clasps, locks, nails, snap-fits, pins, snap-fasteners, spring elements such as ball plungers, zip-ties, magnets, electro-magnets. In particular, a rail may be attached to another rail, or a rail may be attached to a base or mount, for example a wall mount.

Some embodiments may comprise a cushion. A cushion may also be referred to as a buffer element. Suitable materials for the cushion are materials such as elastomer materials, for example silicone, SEBS, TPU. The cushion may be deformable, for example elastically deformable. The cushion may have a friction coefficient different to the rail material. For example, the cushion material may be selected so that pipettes or adapters placed on the rail via (at least in part) the cushion are slidably movable along the rail. A cushion may be formed out of an elongated profile of the cushion material. The cushion may be attached to the rail via any suitable attachment means, for example via gluing.

The material of the parts of this disclosure, for example the rail and/or the adapter, may be aluminium, iron, titanium, steel, alloy steel, bearing steel, stainless steel or any combination or alloy thereof. An exemplary material suitable for use in the context of the disclosure is 6082-T6 aluminum which may be anodized. Such a material is suitable for laboratory use and has a good strength to weight ratio. In addition, plastics may used. In an exemplary embodiment, the system may comprise non-metallic parts, for example for example the rail and/or the adapter for the majority of the parts in order to avoid metal contamination within the laboratory setting. For such an embodiment, robust plastics such as glass fiber filled plastic, carbon fiber filled plastic or polyether ether ketone, PEEK, may be used. A benefit of avoiding metal within the embodiment is reducing the possibility of metal contamination within the laboratory setting as well minimizing the risk of electric short circuits with respect to the electrical components in the devices and components described in the present disclosure.

In the embodiments of the present disclosure, there are provided at least one of an adapter and a rail, as well as a method of use thereof. Such an adapter may be an attachable to a rail with complementary cross-sectional profiles and/or shape. An adapter typically has a complementary shape to a pipette model, type and/or shape, so said pipette is removably attachable to said adapter. In other words, the adapter may be configured to suit a specific pipette. Further, for example, the adapter may be configured to suit a pipette selected from a plurality of pipettes.

According to at least some embodiments of the present disclosure there is provided a rail, to which mechanical pipettes and electronic pipettes may be attached via an adapter. The rail comprises an electrical conductor, such that said electrical conductor extends at least partially along the length of the rail. An electronic pipette may be charged via an adapter on a rail substantially complementary in shape to that of the adapter.

In at least some embodiments of the present disclosure, a suitable adapter may be attached and/or placed on a rail, and charging current from the rail may be conveyed to an electronic pipette connected to said adapter. The current may be conveyed via at least one electric contact, for example charging contacts in said rail, contacts of the electronic pipette and charging contacts of adapter therebetween. Thus, electronic pipettes may be charged via said adapter and rail.

In some embodiments, an adapter suitable for an electronic pipette comprises a body element. Said body element may be shaped at least in part so that body of a desired electronic pipette may removably attached to the body element, wherein the attachment holds the pipette in place relative to the adapter. In some embodiments, the shape of the body element allows for the pipette to be partially inserted into said adapter. Further, the adapter is attachable to a rail having a complementary shape to that of the body element of the adapter. The adapter may comprise one or more charging contacts electrically connected to an electrical conductor of a rail.

In some embodiments, the adapter may further comprise a charging element. Such a charging element may comprise charging contacts electrically attachable to corresponding charging contacts of said electronic pipette. The charging element may have wireless charging capabilities via induction between the adapter and the electronic pipette. In some embodiments, the charging element may comprise a voltage transformer, or a battery charger so as to alter the charging current provided by the rail to be suitable to that of the electronic pipette attached to said adapter. In some embodiments, the adapter provides unaltered charging current to an electronic pipette from electric contacts of a rail to which said adapter is attached.

In some embodiments, the adapter comprises a locking mechanism comprising a spring element such that said adapter is removably attachable to the rail and/or slidable along a rail.

In some embodiments, the adapter is configured to be movable with frictional resistance along a rail, for example wherein the friction is provided by a spring element within the adapter. For example, a spring element within the adapter may be configured to adjust the interference fit between the adapter and the rail. Such a spring element may be, for example a spring or a flexible and/or elastic material providing enough static friction to securely attach said adapter to a rail via interference fit or by pressing a component against the rail. The static friction between the rail and the adapter may be, for example, such that it is comparable to a force of 5 N to 40 N, preferably 10 N, newtons. The friction should be such that adapter is not accidentally movable along a rail to which it is attached to, but movable when so desired by overcoming the friction. Additionally or alternatively, the adapter may comprise a spring-actuated charging contacts such that the connection between the electrical contacts and the electric conductor of the rail may be secured due to the force exerted by a spring element.

In some embodiments, the adapter provides adjustability on the positioning of adapters, and attached pipettes. In some embodiments, the adapter may be removably attachable to a rail such that said adapter is movable and/or slidable along the rail. In some other embodiments, the adapter may comprise a locking mechanism which may, in a “locked” position of the locking mechanism, lock the mounting adapter in place on the rail, and, in another position (an “unlocked” position), unlock the adapter with respect to the rail such that said adapter may be movable along the rail. Thus, such an adapter may be arranged in a stationary position (relative to the rail to which it is attached) when the adapter is in a “locked position”. Said adapter may be slidably movable along the rail when in an “unlocked position”. Additionally or alternatively such locking mechanism may be configured such that said adapter has a “detachment position” and/or “attachment position”, wherein said adapter is detachable from the rail and/or attachable to the rail, respectively. In some embodiments, the “unlocked position” may also comprise the “detachment position” and/or “attachment position”.

A benefit of the movable adapters is that it allows rapid rearrangement of the working setup, for example if different types of pipettes are being used. For example, a multichannel pipette may be wider than a single channel pipette, and consequently may require a wider space. In other words, some pipettes may take up more space along the rail. Using movable adapters, the adapters may be moved farther apart to accommodate differently sized pipettes while still providing charging of the pipettes when needed. Further, for mechanical pipettes, the rail configuration may allow placing and moving the pipettes directly on the rail, further increasing the options available to the user. The embodiments disclosed herein may hold a plurality of different kinds of pipettes via adapters or otherwise along the length of the rail.

In at least some embodiments, there is provided a rail substantially complementary to at least part of a shape of an adapter. The rail comprises at least one electrical conductor, said conductor being configured to provide a charging current to electronic pipette via said adapter, such that said electronic pipette may be charged. When the rail is made of conductive material, the electrical conductor is provided separately from said material. For example, for an aluminium rail, a flat cable may be provided in an internal cavity of said rail. Conductive rail material may be utilized as a ground plane for charging or communication purposes.

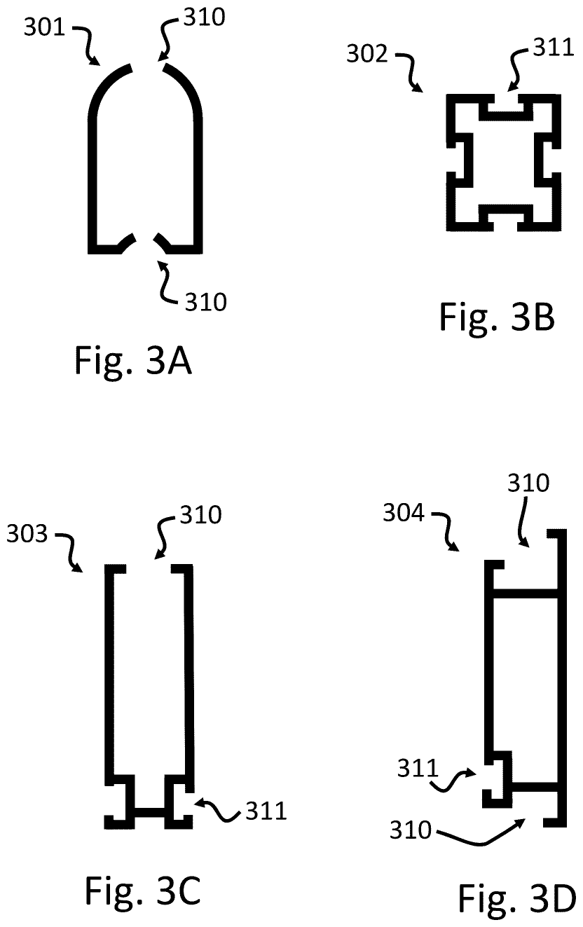

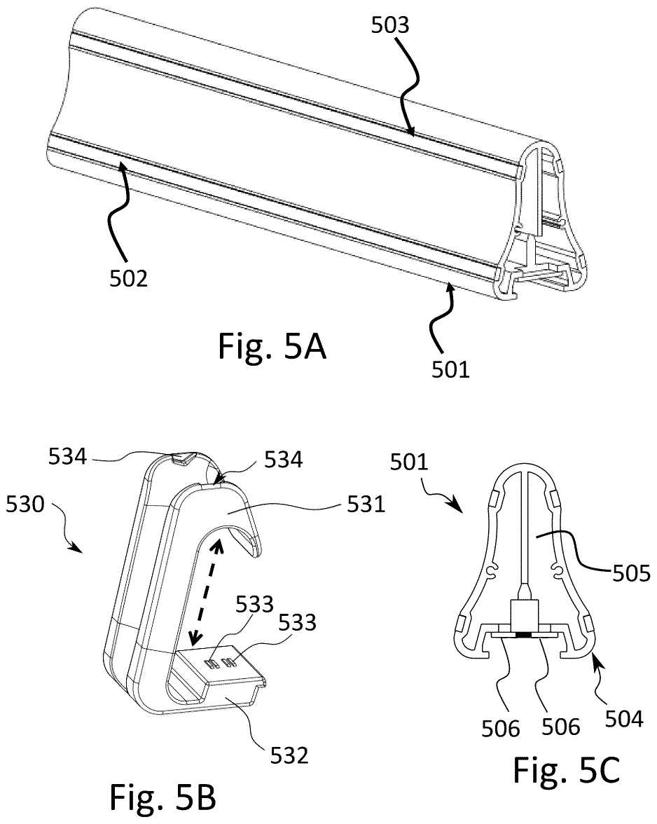

As can be seen in the figures, for example FIGS. 3A-3D and 5C, a rail typically comprises at least one side wall, forming the rail profile. A rail may further comprise at least one internal cavity. The cross-sectional profile of the rail has substantially complementary profile to that of the cross-sectional profile of the adapter, or a portion of the adapter, such that the adapter is removably attachable to said rail, and charging contacts of said adapter are removably attachable to at least one electrical conductor, such as charging contacts, of the rail. In a beneficial embodiment, the rail is elongated and substantially linear, such that adapters and/or pipettes may be movable and/or slidable along said rail. Such an embodiment provides improved placement of adapters and thereby provide pipettes to desired position.

In some embodiments, mechanical pipettes may be directly attachable to the rail. On the other hand, adapters according to some embodiments may be attachable to mechanical pipettes as well. In some further embodiments for mechanical pipettes, charging contacts in the mounting adapter, for both the pipette and rack, may be omitted. Furthermore, in some embodiments, the adapters suitable for an electronic pipette may be suitable for a mechanical pipette as well. The embodiments described are beneficial as mechanical pipettes and electronic pipettes do not necessarily need separate rails, or racks or holders, and as such plurality of different types of pipettes may be attached to the same rail and/or to the same type of rail geometry. Because various pipette-specific adapters may be applied to a same rail at least some embodiments of the present disclosure provide a benefit in terms of diversity for types of pipettes available along such a rail.

In some embodiments, the rail may comprise an elongated electrical conductor such that rail contacts of an adapter are continuously attachable to the rail, for example to provide charging of the electronic pipette attached to the adapter. In other words, the contact between the rail contacts and the elongated conductor is maintained when the adapter is moved along the rail. A benefit of such an elongated electrical conductor in such a rail is the seamless electrical connection between the adapter and the rail even if the position of said adapter is changed. This in turn, provides improved possibilities for position adjustment of the adapter and a possible removably attached pipette thereon. The elongated electrical conductor may be configured to receive electricity from a battery or from an external source, for example mains power.

The rail may be attached or fastened to, for example, a pipette rack, a wall mount, a support leg, or a second rail by any of the following means singly or jointly: mechanical joint, adhesive, hook-or-loop fastener, screws, bolts, clasps, locks, nails, snap-fits, snap-fasteners, zip-ties, magnets, electro-magnets. In addition, the rail may be directly fabricated as part of the device to be attached. End-caps may be configured to fasten or electrically connect a rail to a second entity, for example a second rail. An end-cap is configured to attach to the end of a rail. An end cap may comprise at least one one joint element, said joint element comprising mechanical and electrical connectors and configured to form at least one joint with a counterpart element.

The rail and/or adapter may comprise ports (also termed connectors) such as sockets or through-holes for wires. Such ports are usable at least for unidirectional, bidirectional or peer-to-peer transfer of at least one of: electrical power, communications, control signals, diagnostic information. The ports may be arranged on the elongated surfaces of the rail, or on the end surfaces of the rail. An end cap of a rail may comprise at least one port. Cables may be arranged within the rail. The use of cables as an alternative to wireless transmission provides the benefit of a simpler, faster and more robust signal transmission.

In at least some embodiments, the at least one rail comprises a communication bus. One or more adapters according to the present disclosure may be configured to use the communication bus of the rail. Additionally or alternatively, the adapter and/or the rail may be configured to connect the pipette to the communication bus. A suitable communication bus may comprise at least one of the following: CANBUS, CAN-FD, RS-485, Ethernet, universal serial bus, EtherCAT, USB, WLAN, Bluetooth, RFID communication.

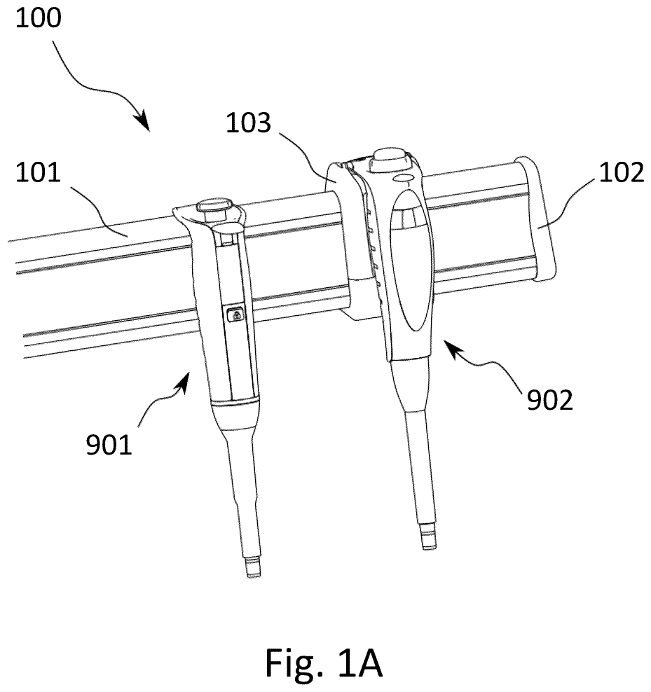

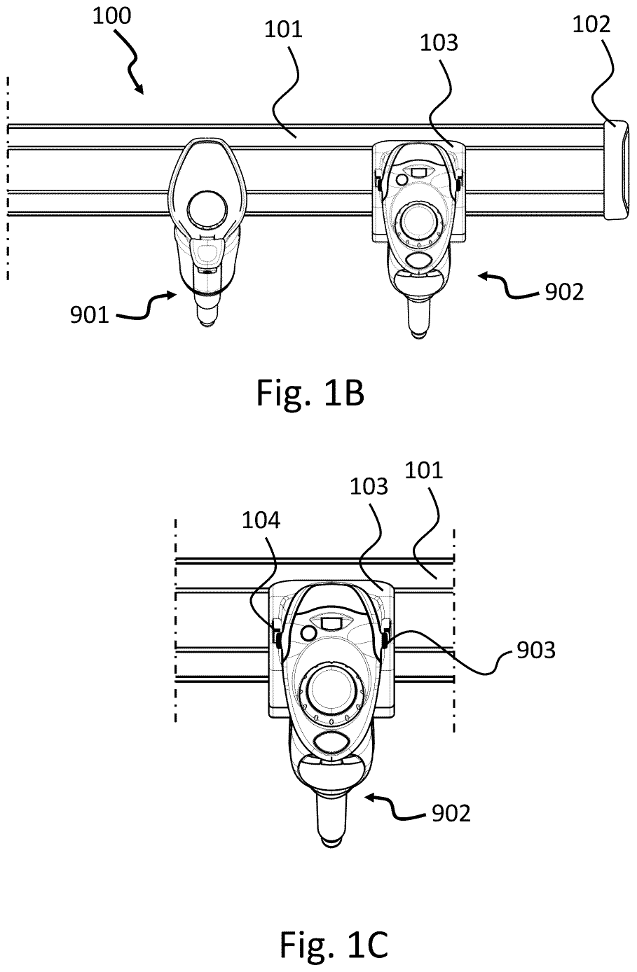

FIGS. 1A, 1B and 1C illustrate an example of a pipette rack arrangement in accordance with at least some embodiments of the present disclosure. Referring to FIG. 1A, pipette rack arrangement 100 is shown, comprising rail 101. The pipette rack arrangement may further comprise rail end cap 102 and pipette adapter 103. End cap 102 is removable from rail 101. The pipette rack arrangement may comprise a mechanical pipette 901 and/or an electronic pipette 902, shown in the figure for purposes of illustration. Rail 101 is complementary in shape to at least part of the shape of the mechanical pipette 901, thereby making it possible to place pipette 901 on the rail 101. The adapter 103 is complementary in shape to an electronic pipette 902. The adapter 103 is also complementary in shape to the rail 101, thereby making it possible to place pipette 902 on the rail 101 by using the adapter.

FIG. 1B shows a top view of the arrangement 100. As can be appreciated from FIGS. 1A-1C, mechanical pipette 901 is removably placeable on the rail 101 without an adapter. In other words, the rail 101 holds a mechanical pipette 901, and the adapter 103 attached to rail 101 holds an electronic pipette 902. As seen on the left side of the rail 101, the dotted line on the rail 101 indicates that the rail may extend indefinitely in that direction.

FIG. 1C shows an enlarged view of FIG. 1B. In FIG. 1C, it can be seen that adapter 103 comprises adapter electric contacts 104. Adapter electric contacts are arranged so that they contact the pipette contacts 903 when the pipette 902 is placed within the adapter 103. Rail 101 may comprise an elongated electrical conductor (not shown). Said elongated conductor may be arranged within the rail or on a surface of the rail. The adapter 103 is arranged to connect the elongated conductor to the adapter contacts 104, thereby providing an electrical connection from the elongated conductor to the pipette. Said electrical connection may provide charging and/or communication to the pipette.

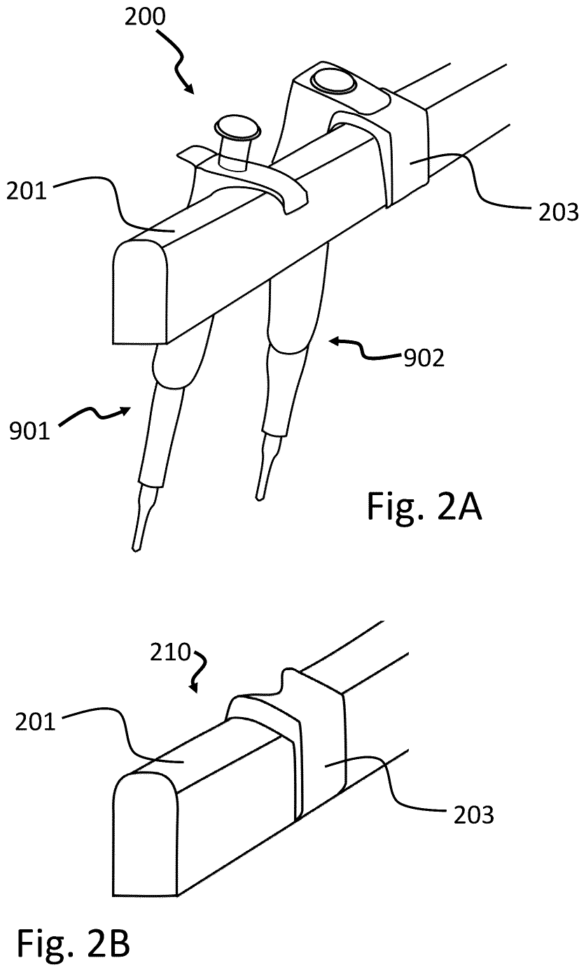

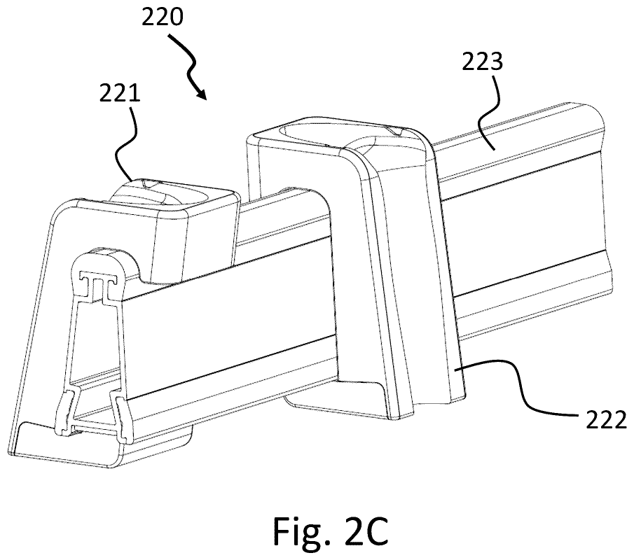

FIGS. 2A, 2B and 2C illustrate pipette rack arrangements in accordance with at least some embodiments of the present disclosure. In the FIG. 2A, pipette rack arrangement 200 is shown, comprising rail 201. The pipette rack arrangement may further comprise pipette adapter 203. An end cap (not shown) may be placed on an end of rail 201. The pipette rack arrangement may comprise a mechanical pipette 901 and/or an electronic pipette 902, shown in the figure for purposes of illustration. Rail 201 is complementary in shape to at least part of the shape of the mechanical pipette 901, thereby making it possible to place pipette 901 on the rail 201. As seen in the figure, this is accomplished by taking advantage of handle shape of pipette 901. The adapter 203 is complementary in shape to an electronic pipette 902. The adapter 203 is also complementary in shape to the rail 101, thereby making it possible to place pipette 902 on the rail 201 by using the adapter. In the figure, the pipette 902 is removably placed in adapter 203.

Rail 201 may comprise an elongated electrical conductor (not shown). Said elongated conductor may be arranged within the rail or on a surface of the rail. The adapter 203 is arranged to connect the elongated conductor to the adapter contacts, thereby providing an electrical connection from the elongated conductor to the pipette 902. Said electrical connection may provide charging and/or communication to the pipette 902.

In the FIG. 2B, pipette rack arrangement 210 is shown, comprising rail 201 and pipette adapter 203. While a mechanical pipette is not shown in the figure, rail 201 is complementary in shape to at least part of the shape of the mechanical pipette 901, thereby making it possible to place pipette 901 on the rail 201. The adapter 203 is complementary in shape to an electronic pipette 902. The adapter 203 is also complementary in shape to the rail 201, thereby making it possible to place pipette 902 on the rail 201 by using the adapter. In the figure, the adapter 203 is removably attached to rail 201. Arrangement 210 is similar to arrangement 200 as discussed above.

In the FIG. 2C, pipette rack arrangement 220 is shown, comprising rail 223 and pipette adapter 221 and pipette adapter 222. While pipette(s) are not shown in the figure, the rail 223 may be complementary in shape to at least part of the shape of a mechanical pipette. The adapters 221 and 222 may be complementary in shape to an electronic pipette. The adapters are complementary in shape to the rail 223, thereby making it possible to place pipette(s) on the rail 223 by using the adapter(s). In the figure, the adapters 221 and 222 are removably attached to rail 223.

The arrangement of FIG. 2C illustrates that in embodiments, adapters may be placed on either side of the rail. In other words, when viewed from the end of the rail, an adapter may be placed on either the left or right side of the rail. Such a configuration provides further flexibility when arranging workspaces. It also saves space as pipettes may be placed on both sides of the rail, whereby the rail length can be potentially reduced. The placement on either side may be implemented, for example, using at least one of: a symmetrical rail profile, having a plurality of conductive elements arranged to facilitate attachment from each side.

FIGS. 3A-3D illustrates schematic cross-sections of some rail profiles in accordance with the present disclosure. FIG. 3A illustrates rail 301, having a top opening 310 and a bottom opening 310. An opening 310 is any cavity in the rail cross-section which allows access into an internal cavity of the rail. Within the cavity, cables such as power cables are typically placed, and so it is beneficial to have access thereto. The openings may be continuous throughout the length of the rail, or periodically arranged along said length. Such openings may be covered by a cover made of a secondary material. Rail 301 further illustrates that the rail may comprise a curved geometry (as at the top of the rail) or an orthogonal geometry (as at the bottom of the rail).

FIG. 3B illustrates rail 302, where the rail is rectangular. Rail 302 comprises four grooves 311. Grooves, such as groove 311, may have differing geometries, such as the T-shaped groove shown in the figure.

FIG. 3C illustrates rail 303, where the rail has a opening 310 at the upper part of the rail cross-section, and two grooves 311 at the lower part. Further, an indentation is present on the bottom surface of the rail.

FIG. 3D illustrates a rail 304 with a groove 311 arranged on a side wall of the rail. Further the top surface and the bottom surface are open as shown in the figure, whereby openings 310 may also be arranged to have narrower openings and then widen towards the interior, and/or wherein the surfaces of the opening may be arranged at different distances from the interior.

As seen within FIG. 3A-3D, several different rail geometries are usable within the context of the present disclosure. For any given rail geometry, a suitable adapter is required so that the desired connection between rail and pipette is formed.

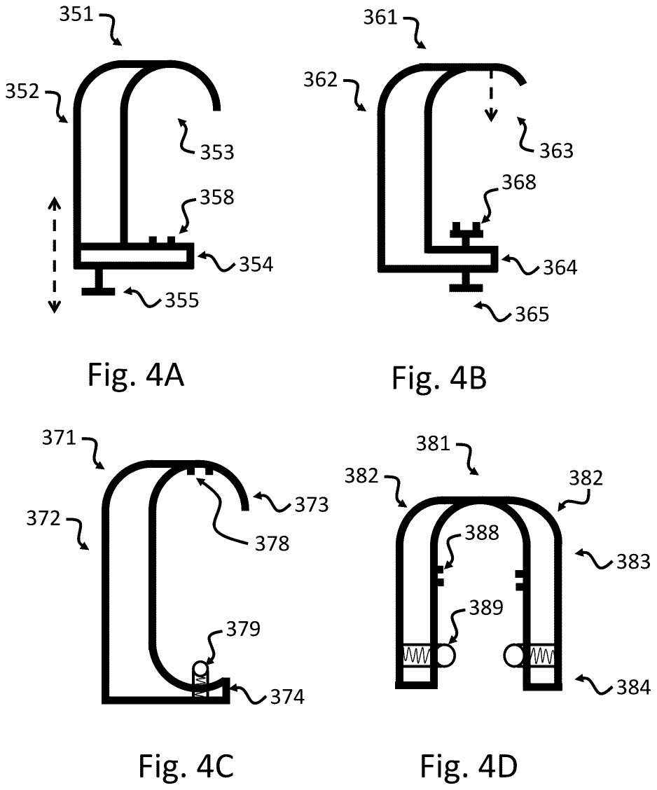

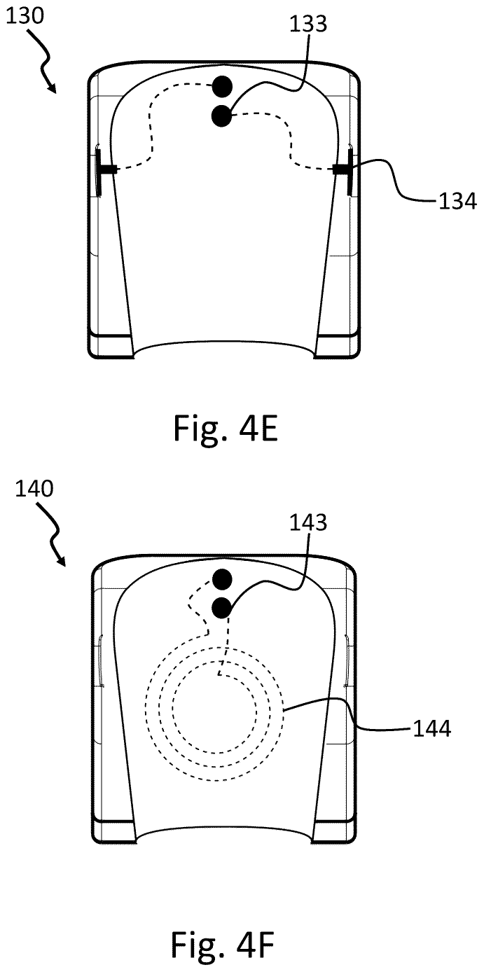

FIGS. 4A-4F illustrate schematic cross-sections of some adapters in accordance with the present disclosure. FIG. 4A illustrates adapter 351 with a focus on the part interfacing with the rail. The rail will be placed within the adapter at least in part. The pipette will be attached to the adapter front, indicated by the reference number 352, using a suitable adapter part or by configuring the adapter body to match the pipette. Adapter 351 comprises upper portion 353, which has a curved shape, and lower portion 354. The lower portion comprises electrical contacts 358. Said charging contacts may be connected to electrical connectors within the adapter in order to convey electrical signals from the contacts to the pipette by means of other contacts arranged to contact the pipette (not shown).

Adapter 351 further comprises optional adjustment knob 355, which may be, for example a retractable spring plunger, or a threaded stud knob. As indicated by the dotted arrow within FIG. 4A, when the knob 355 is actuated in a first direction, for example counter-clockwise, the lower portion 354 moves further from upper portion 353, allowing the adapter to be attached to the rail. When the knob 355 is actuated in a second direction, the lower portion 354 moves toward upper portion 353, forming a suitable fit with the rail. Lower portion 354 may extend into upper portion 353 (not shown) to allow the movement to take place. Knob 355 may be used to adjust the tightness of the fit (interference fit) between the adapter and the rail.

If adapter 351 is provided without the knob 355, the adapter may be configured so that the user pulls downwards on portion 354 to release the adapter from the rail. Responsive to such pulling, a spring within the upper portion 353 allows the distance between portion 353 and portion 354 to increase, and the user can remove the adapter by further pulling the lower portion 354 away from the rail.

FIG. 4B illustrates adapter 361, which is similar to adapter 351. The rail will be placed within the adapter at least in part. The pipette will be attached to the adapter front, indicated by the reference number 362, using a suitable adapter part or by configuring the adapter body to match the pipette. In adapter 361, the contacts 368 are located on a clamp part, said clamp part being actuated by the knob mechanism 365. When the contacts are actuated upward, the upper portion 363 (which is fixedly attached to the lower portion 364) is “pulled” downward, again forming a suitable fit with the rail. Again, knob 365 may be used to adjust the tightness of the fit between the adapter and the rail.

FIG. 4C illustrates adapter 371. The rail will be placed within the adapter at least in part. The pipette will be attached to the adapter front, indicated by the reference number 372, using a suitable adapter part or by configuring the adapter body to match the pipette. In adapter 371, the contacts 378 are arranged on the upper portion 373 of the adapter. Lower portion 374 is fixedly attached to the upper portion 373. The lower portion 374 comprises ball plunger 379. A ball plunger comprises a ball bearing and a spring. When pressure is applied on the ball bearing, the spring retracts, allowing the ball bearing to move away from the pressure. In adapter 371, the attachment to a rail is done by placing the upper portion on the rail and then pushing the lower portion towards the rail. The ball bearing retracts to allow the rail into the adapter. When the rail is within the adapter, the spring pushes the ball bearing to contact the rail, attaching the adapter securely to the rail. The rail may be configured to have a suitable groove (arranged in the lengthwise direction of the rail) for the ball bearing on a surface of the rail. Such a groove provides improved stability.

FIG. 4D illustrates adapter 381. The rail will be placed within the adapter at least in part. The pipette will be attached to the adapter front, indicated by the reference number 382, using a suitable adapter part or by configuring the adapter body to match the pipette. Adapter 381 may comprise two adapter fronts 382, one on each side of the rail, as shown in FIG. 4D. Adapter 381 comprises an upper portion 383 and lower portion 384. The portions may be fixedly attached together. The lower portion comprises at least one, for example two, ball plunger 389. Thus, the adapter 381 may be placed on the rail from above the rail, by pushing the adapter down on to the rail. The ball bearing(s) of the ball plunger(s) will roll along the rail side face until the rail is within the adapter to the desired extent. Lengthwise groove(s) may be provided on the rail side face for the bearing(s). Contact(s) 388 are arranged to contact the side face of the rail. Said contact(s) may be spring actuated as well, so that a good connection is obtained with the electrical conductors arranged on the rail.

As discussed above, several options exist for the adapter arrangement. The dimensions of the adapter, the arrangement of the parts of the adapter is dependent on the rail geometry. This is also true in part regarding the selected attachment mechanism (e.g. movable lower portion, clamp, ball plunger), but for the mechanism the intended use and/or user preference also plays a part. In other words, different adapter attachment mechanisms are usable with a single rail.

In FIGS. 4E and 4F, charging elements of adapters are illustrated using a top view of an adapter. In FIG. 4E, the adapter 130, similar in form to other adapters disclosed herein, is shown. Adapter 130 comprises adapter electric contacts 134. Said electric contacts are arranged so that they contact the pipette contacts when a pipette, for example pipette 902, is placed within the adapter 130. Further, the adapter 130 comprises lower electric contacts 133, which are arranged to contact the rail at a suitable location of the adapter. In other words, electric contacts 133 are not in the vicinity of contacts 134. The adapter 130 is arranged to be attached on a suitable rail in such a way that the lower electric contacts 133 contact the elongated conductor of the rail or ports thereof, thereby providing an electrical connection from the elongated conductor to the adapter. As illustrated by the dotted lines, the electric contacts 133 are connected to adapter electric contacts 134 by suitable conductors within the adapter body. Contacts 134 are arranged to contact the pipette contacts, thereby providing an electrical connection between the elongated conductor and the pipette. Said electrical connection may provide charging and/or communication to the pipette.

In FIG. 4F, the adapter 140, similar in form to other adapters disclosed herein, is shown. Adapter 140 comprises a charging element comprising wireless charging coil 144 within the adapter body. Said coil is arranged so that it interacts with a counterpart charging coil, for example a coil of pipette 902, when such a coil is present in the vicinity of the coil 144. Further, the adapter 140 comprises lower electric contacts 143, which are arranged to contact the rail at a suitable location of the adapter. The adapter 140 is arranged to be attached on a suitable rail in such a way that the lower electric contacts 143 contact the elongated conductor of the rail or ports thereof, thereby providing an electrical connection from the elongated conductor to the adapter. As illustrated by the dotted lines, the electric contacts 143 are connected to the charging coil 144 by suitable conductors within the adapter body. The charging element may comprise further wireless charging components, for example resistors. Said further components may be arranged within the adapter body as well. As discussed above, coil 144 is configured to interact with a counterpart coil of the pipette, thereby providing an electrical connection between the elongated conductor and the pipette. Said electrical connection may provide charging and/or communication to the pipette.

Further, an adapter may comprise both of the charging arrangements discussed above, and be configured to select the arrangement based on the presence of a counterpart coil or charging contacts within the pipette placed in the adapter. Charging arrangements for adapters, for example adapters 103, 351, 361, 371, 381, 530, 560, 580, 603, 653, 673, 703, 753, may be selected from at least: contact charging, wireless charging, or selective contact or wireless charging.

FIGS. 5A, 5B and 5C illustrate a rail and a corresponding adapter in accordance with the present disclosure. In FIG. 5A, rail 501 is shown. Rail 501 comprises elongated grooves 502 and 503. The top surface of the rail 501 is configured to be suitably curved, for example to accommodate the handle of a mechanical pipette, similar to FIG. 2.

In FIG. 5B, adapter 530 is shown. Adapter 530 has a shape suitable for use with rail 501. The complementary shape may be appreciated by comparing the shape of rail in FIGS. 5A and 5C to the adapter shape illustrated in FIG. 5B. As can be appreciated from FIG. 5C, the rail 501 comprises at least one, for example two, electrical conductor(s) 506. When the rail 501 is placed within the adapter 530, the at least one electrical conductor(s) 506 are in contact with electrical contacts 533 of the adapter 530. Thereby, a charging current is provided from the electrical conductors to the adapter, and by extension, provided to an electronic pipette attached to the adapter 530.

Adapter 530 comprises an upper portion 531 and a lower portion 532. The upper portion 531 comprises a cavity (not directly shown) which the lower portion 532 extends into. Together, the portions form a “rail gap”, which is the internal distance from the bottom of the lower portion to the top of the inside of the upper portion. The distance between the portions 531 and 532 may be increased by moving the portions apart along the direction illustrated by the bi-directional dashed arrow. When the portions are so moved, the lower portion is partially removed from the cavity within the upper portion. When extended enough, the adapter is in the “detachment position”, as the portions will be separated and will not clamp the rail. In FIG. 5B, the adapter is shown in the attachment position.

The adapter 530 may comprise a spring element (not shown), for example within the body of the portion 531. The spring element is configured to pull the portions 531 and 532 together via spring tension, so that the portions are securely held together. The spring element is configured to pull the portions along the direction of the dotted arrow. When the portions are held together, or at least held together to the extent the rail within the adapter will allow, the adapter is in the “attachment position”. Thus, the adapter may be securely attached to a complementary rail such as rail 501 of FIGS. 5A and 5B.

The adapter 530 of FIG. 5B is shaped such that an electronic pipette may be attached and/or positioned to the adapter 530. As can be appreciated, the shape of the adapter is complementary to a pipette, such as an electronic pipette, for example pipette 902. The adapter may have notches and or protrusions (not shown) to assist in the positioning and placement of suitably shaped pipettes, for example pipettes with complementary protrusions that fit said notches. The adapter 530 comprises a charging element, arranged within the upper portion 531, said element comprising electric contacts 534. Additionally or alternatively, the charging element may have “wireless charging” capabilities via induction. The charging element is configured to provide electrical signals from contacts 533 to contacts 534.

FIG. 5C shows a cross-section of rail 501. Rail 501 comprises sidewall 504, and at least one internal cavity 505. Rail 501 further comprises conductors 506. Conductors 506 extend throughout the length of the rail. Such an arrangement allows adapters to be connected to the conductors at any point on the rail. End-caps are usable with rail 501.

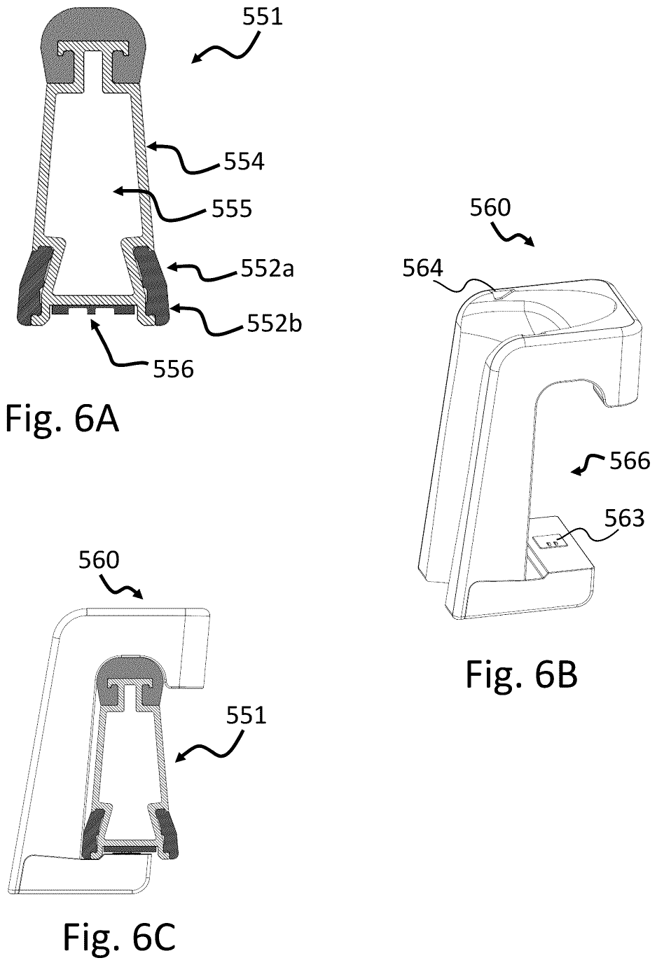

FIGS. 6A, 6B and 6C illustrate a rail and a corresponding adapter in accordance with the present disclosure. In FIG. 6A, a cross-section of rail 551 is shown. Rail 551 comprises sidewall 554, and at least one internal cavity 555. Rail 551 comprises elongated grooves, such as elongated groove 552a. Said grooves may be covered and/or filled at least in part with a cushion, such as cushion 552b. For example, and as shown in FIG. 6A-C, the rail 551 may comprise four elongated grooves, e.g. two grooves at the lower part of the rail, wherein the lower part is the part closer to the conductors 556, and two grooves at the upper part of the rail. For example, the rail may comprise three cushions, wherein at least one cushion is arranged to cover at least two grooves.

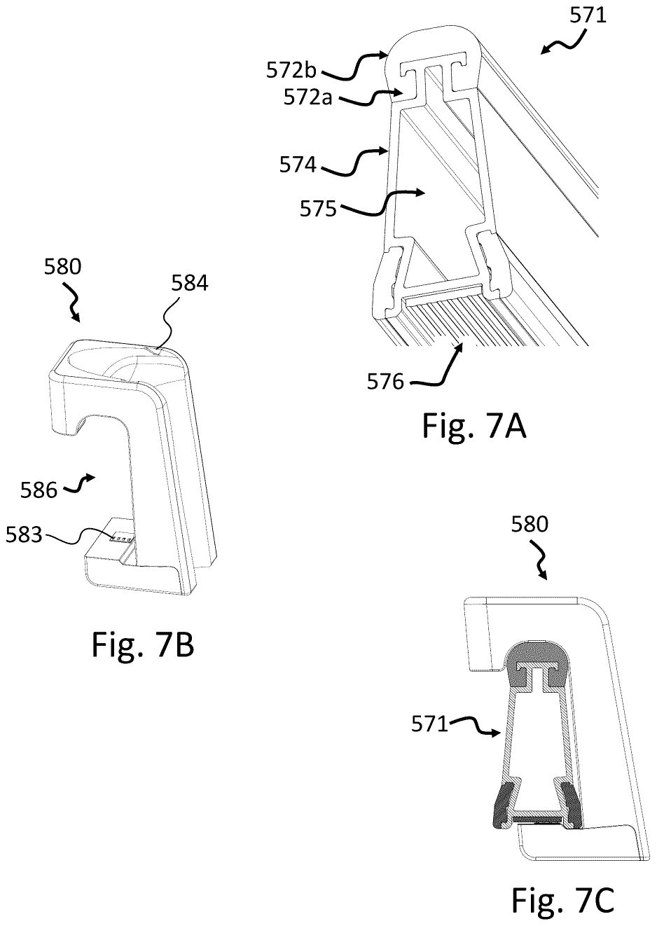

The top surface of the rail 551 is configured, for example at least in part with a cushion, to be suitably curved, to accommodate the handle of a pipette. Rail 551 further comprises conductors 556, in the example of FIGS. 6A-6C, there are at three conductors 556. Embodiments with 2 conductors, or any number of conductors from 2 conductors to 12 conductors are also possible, for example. Having more conductors on the rail compared to contacts on the adapter allows the adapter to be arranged on either side of the rail, as discussed herein with respect to FIG. 7. Conductors 556 may be located within grooves of a conductor element as seen in the figure. Conductors 556 (and the conductor element) extend throughout the length of the rail. Such an arrangement allows adapters to be connected to the conductors at any point on the rail. End-caps are usable with rail 551.

In FIG. 6B, adapter 560 is shown. Adapter 560 has a shape suitable for use with rail 551. The complementary shape may be appreciated by comparing the shape of rail in FIG. 6A to the adapter shape illustrated in FIG. 6B. This is further illustrated and discussed in FIG. 6C.

As the other adapters discussed herein, adapter 560 comprises an upper portion and a lower portion. The upper portion may comprise a cavity (not directly shown) which the lower portion may extend into, or alternatively or additionally the portions may be attached using a hinge. Together, the portions form a “gap” 566, where the rail, for example rail 551, may be placed. The distance between the portions may be adjusted, for example by moving the portions apart. When adjusted enough, the adapter is in the “detachment position”, as the portions will be separated, the gap 566 will be larger than the rail dimensions and thus the adapter will not clamp the rail.

When the portions are held together, for example to the extent that the rail within the adapter will allow, the adapter 560 is in the “attachment position”. Thus, the adapter may be securely attached to a complementary rail.

The adapter 560 of FIG. 6B is shaped such that an electronic pipette may be attached and/or positioned to the adapter 560. As can be appreciated, the shape of the adapter is complementary to a pipette, such as an electronic pipette, for example pipette 902. The adapter may have notches and or protrusions (not shown) to assist in the positioning and placement of suitably shaped pipettes, for example pipettes with complementary protrusions that fit said notches. The adapter 560 comprises a charging element, arranged within the upper portion, said element comprising electric contacts 564. Additionally or alternatively, the charging element may have “wireless charging” capabilities via induction. The charging element is configured to provide electrical signals from contacts 563 to the pipette, for example via contacts 564.

In FIG. 6C, adapter 560 is shown attached to rail 551. When the rail 551 is placed within the adapter 560, the at least two electrical conductor(s) 556 are in contact with electrical contacts 563 of the adapter 560. Thereby, a charging current is provided from the electrical conductors to the adapter, and by extension, provided to an electronic pipette attached to the adapter 560, for example via contacts 564.

FIGS. 7A, 7B and 7C illustrate a rail and a corresponding adapter in accordance with the present disclosure. In FIG. 7A, a section of rail 571 is shown. Rail 571 comprises sidewall 574, and at least one internal cavity 575. End-caps are usable with rail 571. Rail 571 comprises elongated grooves, such as elongated groove 572a. Said grooves may be covered and/or filled at least in part with a cushion, such as cushion 572b. For example, and as shown in FIG. 7A-C, the rail 571 may comprise four elongated grooves, e.g. two grooves at the lower part of the rail, wherein the lower part is the part closer to the charging elements 576, and two grooves at the upper part of the rail. For example, the rail may comprise three cushions, wherein at least one cushion is arranged to cover at least two grooves.

The top surface of the rail 571 is configured, for example at least in part with a cushion, to be suitably curved, to accommodate the handle of a pipette. Rail 571 further comprises conductors 576, in the example of FIGS. 7A-7C, there are seven conductors 576. In the corresponding adapter 580, there are four contacts. A plurality of contacts may be useful, for example when both power transmission and bus communication are facilitated using the contacts. For example, power transmission may use two contacts, and communication the other two contacts. The communication and power functions may also share a contact, for example a ground contact. Having more conductors on the rail compared to contacts on the adapter allows the adapter to be arranged on either side of the rail. In other words, if the adapter is arranged on the left side of the rail, the rail having seven conductors and the adapter four contacts, then the first four conductors are used by the adapter and the next three conductors are not used by said adapter. If the same adapter is arranged on the right side of the same rail, then the first (counting from the left) three conductors are not used and the next four conductors are used by the adapter. In this example, the fourth conductor is used when an adapter is attached to the rail from either side. Not all conductors need be used when an adapter is attached.

Conductors 576 may be located within grooves of a conductor element as seen in the figure. Conductors 576 (and the conductor element) extend throughout the length of the rail. Such an arrangement allows adapters to be connected to the conductors at any point on the rail.

In FIG. 7B, adapter 580 is shown. Adapter 580 has a shape suitable for use with rail 571. The complementary shape may be appreciated by comparing the shape of rail in FIG. 7A to the adapter shape illustrated in FIG. 7B. This is further illustrated and discussed in FIG. 7C.

As with other adapters discussed herein, adapter 580 comprises an upper portion and a lower portion. The upper portion may comprise a cavity (not directly shown) which the lower portion may extend into, or alternatively or additionally the portions may be attached using a hinge. Together, the portions form a “gap” 586, where the rail, for example rail 571, may be placed. The distance between the portions may be adjusted, for example by moving the portions apart. When adjusted enough, the adapter is in the “detachment position”, as the portions will be separated, the gap 586 will be larger than the rail dimensions and thus the adapter will not clamp the rail.

When the portions are held together, for example to the extent that the rail within the adapter will allow, the adapter 580 is in the “attachment position”. Thus, the adapter may be securely attached to a complementary rail.

The adapter 580 of FIG. 7B is shaped such that an electronic pipette may be attached and/or positioned to the adapter 580. As can be appreciated, the shape of the adapter is complementary to a pipette, such as an electronic pipette, for example pipette 902. The adapter may have notches and or protrusions (not shown) to assist in the positioning and placement of suitably shaped pipettes, for example pipettes with complementary protrusions that fit said notches. The adapter 580 comprises a charging element, arranged within the upper portion, said element comprising electric contacts 584. Additionally or alternatively, the charging element may have “wireless charging” capabilities via induction. The charging element is configured to provide electrical signals from contacts 583 to the pipette, for example via contacts 584.

In FIG. 7C, adapter 580 is shown attached to rail 571. When the rail 571 is placed within the adapter 580, at least four of the electrical conductor(s) 576 are in contact with electrical contacts 583 (of which there are four) of the adapter 580. The use of the conductors 576 will depend on which side the adapter 580 is placed with respect to the rail 571, as previously discussed. By such an electrical contact between conductors 576 and contacts 583, a charging current is provided from the electrical conductors to the adapter, and by extension, provided to an electronic pipette attached to the adapter 580, for example via contacts 584.

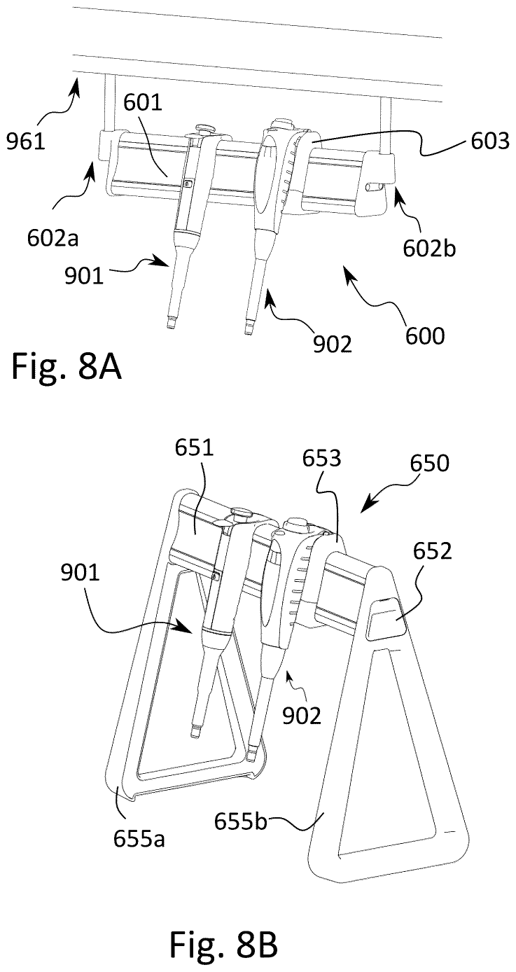

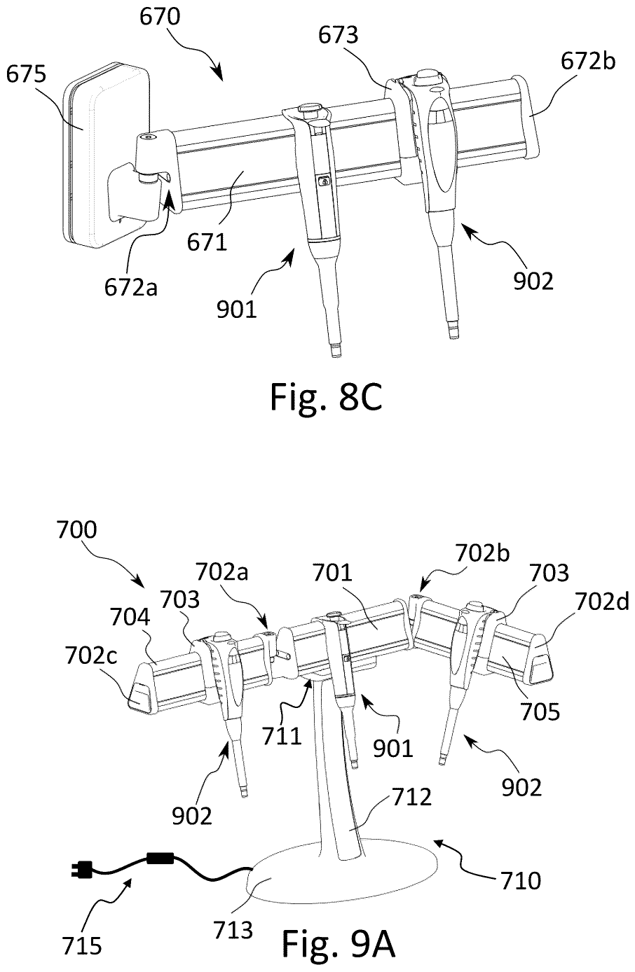

FIGS. 8A, 8B and 8C illustrate rail and adapter configurations capable of supporting at least some embodiments of the present disclosure. FIG. 8A illustrates a pipette rack arrangement 600. Pipette rack arrangement 600 is attachable to an overhead surface 961, for example a shelf or a table. Pipette rack arrangement 600 comprises at least one rail, for example rail 601, as seen in the figure. Rail 601 may be any suitable rail, for example any of the rails disclosed herein, for example any one of rails 101, 201, 301, 302, 303, 304 or 501. Rail 601 comprises at least one elongated electrical conductor. Rail 601 is attached to endcaps 602a and 602b, which are configured to act as connector elements. Endcaps 602a and 602b may comprise vertical connectors, or vertical connectors may be attached to the endcaps. Vertical connectors may be arranged to be attached to the underside of the overhead surface, as seen in the figure, or they may be arranged to be attached to the top side of the overhead surface, for example being clamped to the overhead surface. Endcaps 602a and 602b are configured to attach the pipette rack arrangement 600 to an overhead surface via the vertical connectors.

Pipettes 901 and 902 are shown attached to the pipette rack arrangement 600 in an exemplary configuration. As seen in the figure, pipette rack arrangement 600 may comprise one or more adapters 603 to allow electronic pipettes to be attached to rail 601. Adapters 603 may be any suitable adapter, for example any of the adapters disclosed herein, for example any one of adapters 103, 130, 140, 351, 361, 371, 381, 530.

A benefit of pipette rack arrangement 600 is that the rail may be configured to match the width of the overhead surface 961. In other words, the length of the pipette rack arrangement may be configured to be substantially equal to the width of the overhead surface, allowing the use of the arrangement with pre-existing laboratory equipment, such as shelves, work tables, or other furniture. This arrangement also saves space, i.e. it has a small physical footprint. This is especially important for space-limited environments such as

### Laminar Flow Cabinets.

In FIG. 8B, a freestanding (also termed table-top) pipette rack arrangement 650 is illustrated. Pipette rack arrangement 650 comprises a rail 651, endcaps 652, and legs 655a and 655b. Rail 651 may be any suitable rail, for example any of the rails disclosed herein, for example any one of rails 101, 201, 301, 302, 303, 304 or 501. Rail 651 comprises at least one elongated electrical conductor. Legs 655a and 655b are configured to connect to the rail 651, and endcaps 652 are configured to secure the connection between rail and legs. The endcaps may comprise a fastening means (not shown), for example a screw or bolt, to ensure the legs and rail are not separated.

Pipettes 901 and 902 are shown attached to the pipette rack arrangement 650 in an exemplary configuration. As seen in the figure, pipette rack arrangement 650 may comprise one or more adapters 653 to allow electronic pipettes to be attached to rail 601. Adapter 653 may be any suitable adapter, for example any of the adapters disclosed herein, for example any one of adapters 103, 130, 140, 351, 361, 371, 381, 530.

A benefit of pipette rack arrangement 650 is that the rail may be configured to be any suitable length. Further, the construction of arrangement 650 is mechanically robust and allows using the arrangement from both sides of the rail.

FIG. 8C illustrates a pipette rack arrangement 670. Pipette rack arrangement 600 is attachable to a vertical surface, for example a wall (not shown in the figure). Pipette rack arrangement 670 comprises at least one rail, for example rail 671, as seen in the figure. Rail 671 may be any suitable rail, for example any of the rails disclosed herein, for example any one of rails 101, 201, 301, 302, 303, 304 or 501. Rail 671 comprises at least one elongated electrical conductor. The arrangement further comprises endcap 672a, and optionally endcap 672b. Endcaps 672a is configured to act as a connector element to wall mount 675. The arrangement may further comprise wall mount 675. Endcap 672a is configured to attach the pipette rack arrangement 670 to a vertical surface, for example via wall mount 675.

Endcaps 672a and wall mount 675 are configured to act together as a hinge joint. When the endcap 672a is connected to the wall mount 675, the rail 671 may be manually actuated along the hinge. Wall mount 675 may be attached to a vertical surface using fastening means (not shown), for example screws or magnets.

Pipettes 901 and 902 are shown attached to the pipette rack arrangement 670 in an exemplary configuration. As seen in the figure, pipette rack arrangement 670 may comprise one or more adapters 673 to allow electronic pipettes to be attached to rail 671. Adapter 673 may be any suitable adapter, for example any of the adapters disclosed herein, for example any one of adapters 103, 130, 140, 351, 361, 371, 381, 530.

A benefit of pipette rack arrangement 670 is that the arrangement may be placed at an ergonomically suitable height. Further, the arrangement may be rotated into a suitable angle, and rotated to be close to the wall, for example when not in use. This arrangement also saves space, i.e. it has a small physical footprint. This is especially important for space-limited environments such as laminar flow cabinets.

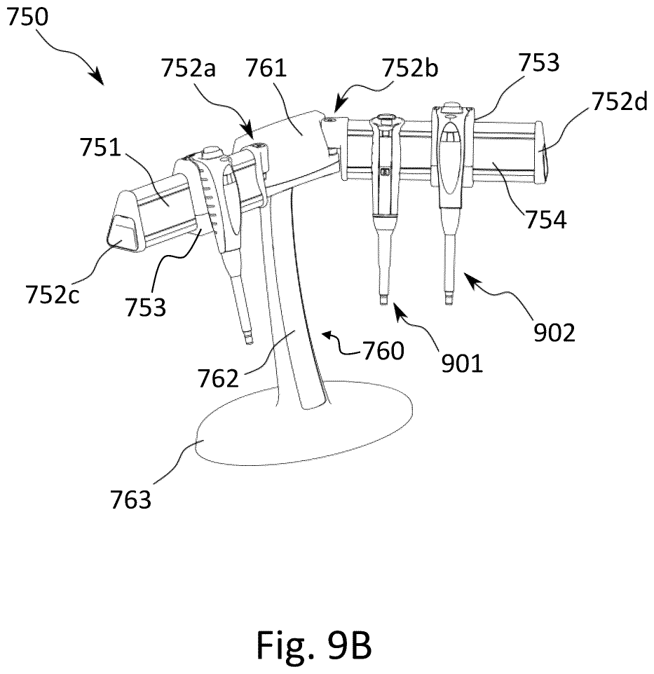

FIGS. 9A and 9B illustrate pipette rack arrangements capable of supporting at least some embodiments of the present disclosure. FIG. 9A illustrates a pipette rack arrangement 700, which is a freestanding (also termed table-top) arrangement. Pipette rack arrangement 700 comprises at least one rail 701 and a base 710. Optionally, arrangement 700 may further comprise any combination of the following: additional rail 704, additional rail 705, one or more adapters 703, hinged endcap 702a, hinged endcap 702b, endcap 702c, or endcap 702d. Rails 701, 704, and/or 705 may be any suitable rail, for example any of the rails disclosed herein, for example any one of rails 101, 201, 301, 302, 303, 304 or 501. Rail 701 comprises an elongated electrical conductor. Rails 704 and/or 705 may comprise an elongated electrical conductor.

Rail 701 may be connected to at least one hinged endcap, for example hinged endcap 702a and/or hinged endcap 702b. The hinged endcaps, together with the counterpart endcaps of the rail 701, are configured to act as a hinge joint. When the rail 701 is connected to rail 705 using endcap 702b, the rail 705 may be manually actuated with respect to rail 701 along the hinge. When the rail 701 is connected to rail 704 using endcap 702a, the rail 704 may be manually actuated with respect to rail 701 along the hinge. The endcaps may be configured to provide power from rail 701 to the additional rails.

Base 710 comprises a rail connector 711, a stem 712, and a base 713. The rail connector 711 is connected to the stem 712, which is connected to the base 713. The rail connector is configured to removably attach to the rail 701. The base may further comprise electrical conductors (not shown) which provide electrical connections to the rail 701 via the rail connector 711. The base may further comprise a power input cord 715, which may comprise a transformer unit. Power input cord 715 is connected to the electrical conductors of base 710.

A plurality of pipettes 901 and 902 are shown attached to the pipette rack arrangement 700 in an exemplary configuration. As seen in the figure, pipette rack arrangement 700 may comprise one or more adapters 703 to allow electronic pipettes to be attached to any of rails 701, 704 or 705. Adapter 703 may be any suitable adapter, for example any of the adapters disclosed herein, for example any one of adapters 103, 130, 140, 351, 361, 371, 381, 530.

A benefit of pipette rack arrangement 700 is that the arrangement may be flexibly arranged according to the needs of the application or user. The length of the main rail 701 and the additional rails may be freely selected, and the angles of the additional rails may be moved manually during use. Further, the arrangement may be folded into a space-saving configuration by adjusting the angles of the additional rails.

FIG. 9B illustrates a pipette rack arrangement 750, which is a freestanding (also termed table-top) arrangement. Pipette rack arrangement 750 comprises at least one rail 751 and a base 760. Optionally, arrangement 700 may further comprise any combination of the following: additional rail 754, one or more adapters 753, hinged endcap 752a, hinged endcap 752b, endcap 752c, or endcap 752d. Rails 751 and/or 754 may be any suitable rail, for example any of the rails disclosed herein, for example any one of rails 101, 201, 301, 302, 303, 304 or 501. Rail 754 comprises an elongated electrical conductor. Rail 754 may comprise an elongated electrical conductor.

Rail 751 may be connected to at least one hinged endcap, for example hinged endcap 752a. The hinged endcap, together with the counterpart endcap of the base top 761, is configured to act as a hinge joint. When the rail 751 is connected to the top 761 using endcap 752a, the rail 751 may be manually actuated with respect to top 761 along the hinge. Similarly, when the rail 754 is connected to the top 761 using hinged endcap 752b, the rail 754 may be manually actuated with respect to top 761 along the hinge. The endcaps may be configured to provide power from top 761 to the rails 751 and/or 754.

Base 760 comprises a base top 761, a stem 762, and a base 763. The base top 761 is connected to the stem 762, which is connected to the base 763. The base top may comprise a desk area, suitable for attaching a tablet or placing laboratory equipment. The base may further comprise electrical conductors (not shown) which provide electrical connections to the rails 751 and/or 754 via the base top 761. The base may further comprise a power input cord (not shown) connected to the electrical conductors of the base.

A plurality of pipettes 901 and 902 are shown attached to the pipette rack arrangement 750 in an exemplary configuration. As seen in the figure, pipette rack arrangement 750 may comprise one or more adapters 753 to allow electronic pipettes to be attached to any of rails 751, 754. Adapter 753 may be any suitable adapter, for example any of the adapters disclosed herein, for example any one of adapters 103, 130, 140, 351, 361, 371, 381, 530.

A benefit of pipette rack arrangement 750 is that the arrangement may be flexibly arranged; the length of the rails may be freely selected, and the angles of the additional rails may be moved manually during use. Further, the arrangement may be folded into a space-saving configuration by adjusting the angles of the additional rails. Base top 761 provides an area for a tablet which may assist during laboratory work.

The present disclosure provides several benefits. A benefit of using a rail within a pipette rack or holder is that the rail length can be adjusted for any specific user need, for example by shortening the rail. The user can shorten the rail themselves, using e.g. a hacksaw. A rail may provide working flexibility to the user, for example if the rail is at least the length of the working surface. In such a situation, the pipettes may be flexibly placed anywhere on the rail, allowing the user to arrange the working setup to their liking. When adapters are used, the adapters need to be placed at the desired location. Several adapters may be used for a single pipette.

Another benefit is that the rail may comprise a generic, universal, or near-universal geometry in terms of shape and profile because adapters may be configured to be pipette-specific. This is because the adapter can “adapt” the shape of the pipette to the desired rail profile. Thus, many different pipette types and models comprising various shapes may be attachable to the desired rail, when the adapters are used. Moreover, because of the possibilities of implementing a generic rail shape and desired, adjustable rail length, such a rail may be easily incorporable even to existing pipette racks and designs thereof, including, for example, overhead mounted racks, under-surface mounted racks, wall-mounted holders, and table-top stands. According to at least some embodiments, a pipette rack or pipette holder may comprise such a rail.

The present disclosure can also be utilized via the following clauses.

Clause 1. A system for holding a pipette, the system comprising: an adapter comprising: a body element configured to hold a pipette; and a rail comprising at least one electrical conductor, said electrical conductor extending at least partially along the length of the at least one rail, the adapter being configured to be attached to at least one rail at any point along the rail.

Clause 2. The system of clause 1, wherein the adapter comprises a charging element, wherein the adapter is configured to connect the charging element to the at least one electrical conductor of the at least one rail when the adapter is attached to the at least one rail, and wherein the charging element comprises at least one of: an electrical contact, a wire, or a coil configured for wireless charging.

Clause 3. The system of clause 1 or clause 2, wherein the rail is configured to be attached via at least one endcap to at least one of: a wall mount, a support leg, or a second rail.

Clause 4. A system for holding a pipette, the system comprising a rail comprising at least one electrical conductor, said electrical conductor extending at least partially along the length of the at least one rail, wherein the system is configured to be attached to an overhead surface via endcap attachment units (602a, 602b).

Clause 5. A system for holding a pipette, the system comprising a rail comprising at least one electrical conductor, said electrical conductor extending at least partially along the length of the at least one rail, wherein the system comprises support legs (655a, 655b) and wherein the system is configured to stand on a flat surface via said support legs, said support legs being connected to the rail and wherein endcaps (652) are configured to secure the connection between the rail and the support legs.

Clause 6. A system for holding a pipette, the system comprising a rail comprising at least one electrical conductor, said electrical conductor extending at least partially along the length of the at least one rail, wherein the system comprises a wall mount (675), elements configured to function as a hinge, wherein an endcap forms at least part of the hinge, said endcap configured to connect the rail to the wall mount and wherein the system is configured to be attached to a vertical surface via the wall mount and to rotate along the hinge axis.

Clause 7. A system for holding a pipette, the system comprising a rail comprising at least one electrical conductor, said electrical conductor extending at least partially along the length of the at least one rail, wherein the system comprises a base (710), said base comprising a rail connector (711), a stem (712) and a base foot (713), wherein the rail connector is configured to be attached to the rail, and wherein the stem is connected to the rail connector and the base foot, wherein the system is configured to stand on a flat surface via said base.

Clause 8. The system of clause 7, wherein the rail is further hingedly connected to at least one additional rail (705).

Clause 9. A system for holding a pipette, the system comprising a rail comprising at least one electrical conductor, said electrical conductor extending at least partially along the length of the at least one rail, wherein the system comprises a base (760), said base comprising a base top (761), a stem (762) and a base foot (763), wherein the base top is configured to be attached to the rail, and wherein the stem is connected to the base top and the base foot, wherein the system is configured to stand on a flat surface via said base.

Clause 10. The system of clause 7, wherein the base top is hingedly connected to the rail, and wherein the base top is optionally hingedly connected to at least one additional rail (754).

Clause 11. The system of any one of clauses 4 to 10, the system comprising an adapter comprising: a body element configured to hold a pipette; the adapter being configured to be attached to at least one rail at any point along the rail.

Clause 12. The system of clause 11, wherein the adapter comprises a charging element, wherein the adapter is configured to connect the charging element to the at least one electrical conductor of the at least one rail when the adapter is attached to the at least one rail, and wherein the charging element comprises at least one of: an electrical contact, a wire, or a coil configured for wireless charging.

Clause 13. The system of any one of the preceding clauses, wherein the system comprises an electric pipette, wherein the system comprises at least one adapter configured to hold and/or charge said electric pipette.

Clause 14. The system of any one of the preceding clauses, wherein the system comprises a pipette, wherein the rail is configured so that the pipette may be directly placed on the rail, wherein the placing uses, for example, a hook on the upper end of the pipette.

Clause 15. The system of any one of the preceding clauses, wherein the rail comprises at least two conductors, preferably at least five conductors, in particular seven conductors.

Clause 16. The system of any one of the preceding clauses, wherein the rail is connected to and also comprises a communication bus and wherein the adapter is configured to use the communication bus of the rail, for example via contacts, and/or connect the pipette to the communication bus.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

At least some embodiments of the present invention find industrial application in automated liquid handling devices, more specifically in attaching apparatuses to such devices in an adjustable manner.

### ACRONYMS LIST

CAN-FD Controller Area Network-Flexible Data Rate
CANBUS Controller Area Network Bus
RFID Radio-Frequency Identification
PEEK polyether ether ketone
SEBS Styrene-Ethylene-Butylene-Styrene
TPU Thermoplastic Polyurethane
USB Universal Serial Bus
WLAN Wireless Local Area Network

### REFERENCE SIGNS LIST

100, 200, 210, 220, 600, 650, 670, 700, 750 Arrangement
101, 201, 223, 301, 302, 303, 304, 501, 551, 571, 601, 651, 671, 701, 704, 705, 751, 754 Rail
102, 602a, 602b, 652, 672a, 672b, 702a, 702b, 702c, 702d, 752a, 752b, 752c, 752d Endcap
103, 130, 140, 203, 221, 222, 351, 361, 371, 381, 530, 560, 580, 603, 653, 673, 703, 753 Adapter
104, 133, 134, 143, 358, 368, 388, 378, 533, 534, 563, 564, 583, 584 Adapter contacts
506, 556, 576 Rail conductor
144 Wireless charging coil
310 Opening
311, 502, 503, 552a, 572a Groove
552b, 572b Cushion
352, 362, 372, 382 Adapter front
353, 363, 373, 383, 531 Adapter upper portion
354, 364, 374, 384, 532 Adapter lower portion
355, 365 Knob mechanism
379, 389 Ball plunger
504, 554, 571, 574 Sidewall
505, 555, 575 Cavity
566, 586 Gap
655a, 655b Legs
675 Wall mount
710, 760 Base assembly
711 Rail connector
712, 762 Stem
713, 763 Base foot
715 Power input cord
761 Base top
901 Mechanical pipette
902 Electronic pipette
903 Pipette contacts
961 Overhead surface

1. An adapter for holding a pipette, the adapter comprising:
a body element, said body element configured to hold a pipette;
wherein the adapter is configured to be attached to at least one rail at any point along the rail, said at least one rail comprising at least one electrical conductor, said electrical conductor extending at least partially along the length of the at least one rail.

2. The adapter of claim 1, wherein the adapter is configured so that the adapter is slidably movable along the at least one rail.

3. The adapter of claim 1, wherein the adapter is configured to be movable with frictional resistance along the at least one rail, for example wherein a spring element within the adapter is configured to adjust the interference fit between the adapter and the rail.

4. The adapter of claim 1, wherein the adapter is configured to have a locked position and an unlocked position, wherein in the locked position the adapter is locked in a stationary position relative to the at least one rail, and wherein in the unlocked position the adapter is slidably movable along the at least one rail, for example movable with frictional resistance.

5. The adapter of claim 1, wherein the adapter is configured to have a detachment position in which said adapter is detachable from the rail, and an attachment position, wherein said adapter is attached to the rail.

6. The adapter of claim 1, wherein the adapter comprises a charging element, wherein the adapter is configured to connect the charging element to the at least one electrical conductor of the at least one rail when the adapter is attached to the at least one rail, and
wherein the charging element comprises at least one of: an electric contact, a wire, or a coil configured for wireless charging.

7. The adapter of claim 1, wherein the adapter is configured to maintain the connection of the charging element to the at least one electrical conductor of the at least one rail when the adapter is moved along the rail.

8. The adapter of claim 1, wherein the adapter is configured so that pulling downward on a lower portion of the adapter will result in at least one of: the unlocked position, the detachment position.

9. The adapter of claim 1, wherein the at least one rail further comprises a communication bus and wherein the adapter is configured to use the communication bus and/or connect the pipette to the communication bus.

10. A rail for holding at least one pipette, the rail comprising:
at least one electrical conductor, said electrical conductor extending at least partially along the length of the rail;,
wherein the rail is configured to allow at least one adapter to be attached at any point along the rail, the adapter comprising a body element configured to hold a pipette, and
wherein the rail is configured to be attached to at least one connector element, said connector element attached to at least one of: a wall mount, a support leg, or a second rail.

11. The rail of claim 10, wherein the rail is configured to allow an adapter to be attached from either side of the rail, wherein for example the rail has a symmetrical profile.

12. The rail of claim 10, wherein the rail is configured to be supported by and connected to, by the connector element, at least one stand comprising at least one supporting element.

13. The rail of claim 10, wherein the rail comprises at least two rail elements, wherein the first and second rail elements are connected to one another by at least one joint element, said joint element comprising mechanical and electrical connectors and at least one joint.

14. A system for holding a pipette, the system comprising:
an adapter for holding a pipette, the adapter comprising a body element, said body element configured to hold the pipette;
a rail for holding at least one adapter, the rail comprising at least one electrical conductor, said electrical conductor extending at least partially along the length of the rail;
wherein the rail is configured to allow at least one adapter to be attached at any point along the rail, and
wherein the rail is configured to be attached to at least one connector element, said connector element attached to at least one of: a wall mount, a support leg, or a second rail.

15. The system of claim 14, wherein the system further comprises an electronic pipette.

16. A method of providing a pipette holding system, the method comprising:
attaching an adapter to a rail, said rail comprising at least one electrical conductor, said electrical conductor extending at least partially along the length of the rail;, wherein the adapter comprises a body element configured to hold a pipette and the adapter is configured to be movably attached to the rail at any point along the rail.

17. The method of claim 16, wherein the adapter is configured to have a locked position and an unlocked position, wherein in the locked position the adapter is locked in a stationary position relative to the at least one rail, and wherein in the unlocked position the adapter is slidably movable along the at least one rail, for example movable with frictional resistance.

18. The method of claim 16, wherein the adapter comprises a charging element and wherein the adapter is configured to connect the charging element to the at least one electrical conductor of the rail.
